(19) United States
(12) Patent Application Publication
(10) Pub. No.: US 2025/0202248 A1
(43) Pub. Date: Jun. 19, 2025

(54) BATTERY MODULE FOR BALANCING A BATTERY GROUP AND ASSOCIATED INTEGRATED CONTROL CIRCUIT AND METHOD

(71) Applicant: Chengdu Monolithic Power Systems Co., Ltd., Chengdu (CN)

(72) Inventor: Lei Du, Hangzhou (CN)

(21) Appl. No.: 18/979,564

(22) Filed: Dec. 12, 2024

(30) Foreign Application Priority Data
Dec. 13, 2023 (CN) 202311716665.8

(51) Int. Cl. H02J 7/00; H01M 10/42; H01M 10/44

(52) U.S. Cl. CPC H02J 7/0019; H01M 10/425; H01M 10/441; H02J 7/007182; H01M 2010/4271; H02J 2207/20

(57) ABSTRACT

A battery module and method for balancing a battery group with n (n≥3) battery cells connected by ordinal in a series structure, each battery cell has an anode and a cathode. The battery module has an energy transfer unit with a pair of switches and an inductor. The pair of switches is coupled between the anode of the nth battery cell and the cathode of the 1st battery cell. A switch node of the pair of switches is connected to a first terminal of the inductor, and a second terminal of the inductor is selectively coupled to the anode or the cathode of a target cell in the battery group. The energy transfer unit operates in a buck mode or a boost mode for transferring energy among the n battery cells of the battery group.

### CROSS-REFERENCE TO RELATED APPLICATIONS

This application claims the benefit of CN application Ser. No. 202311716665.8, filed on Dec. 13, 2023, and incorporated herein by reference.

### TECHNICAL FIELD

The present invention generally relates to electronic circuits, and more particularly but not exclusively, to battery modules for balancing a battery group and associated methods and integrated control circuits.

### BACKGROUND

A battery group includes a certain number of battery cells in a series structure as needed. There are more or less differences among the battery cells of the battery group in many parameters including charging status, impedance and/or temperature characteristics, the capacities of a battery module with such battery group can get mis-matched. The mis-matched battery cells would results in reduction of total capacity and life span of the battery module. Thus, it is necessary to use battery balance control to balance the battery cells in the battery group, to ensure battery capacity and stable performance.

FIG. 1 schematically shows a prior battery system 10 with a passive balance circuit. As shown in FIG. 1, bypass resistors and bypass FETs (field effect transistor) are connected to the corresponding battery cells in parallel. When a voltage across one battery cell is higher than that of the rest battery cells, the battery cell with higher voltage is discharged through the corresponding bypass resistors and FET. The efficiency of the battery system 10 of FIG. 1 is low due to the power loss.

FIG. 2 schematically shows a prior battery system 20 with an active balance circuit. As shown in FIG. 2, the battery system 20 comprises capacitors coupled between every two adjacent battery cells. The capacitor stores and releases energy to balance the corresponding two adjacent battery cells. The battery system 20 of FIG. 2 can only balance two adjacent battery cells. Furthermore, the efficiency of the battery system 20 is low since a lot of energy is wasted during the charge of the capacitors.

FIG. 3 schematically shows another prior battery system 30 with an active balance circuit. As shown in FIG. 3, the battery system 30 comprises a transformer and energy can be transferred from a battery pack to an individual battery cell through the transformer. However, the size and the cost of the battery system are increased because of the transformer.

FIG. 4 schematically shows still another prior battery system 40 with an active balance circuit. As shown in FIG. 4, the battery system 40 comprises several inductors and the battery system 40 can work as a buck-boost converter to transfer energy between two adjacent battery cells. The battery system 40 of FIG. 4 can only balance two adjacent battery cells and its efficiency is limited.

### SUMMARY

An embodiment of the present invention discloses a battery module for balancing a battery group. The battery group has n battery cells connected by ordinal in a series structure, n is an integer higher than 2. Each battery cell has an anode and a cathode. The battery module has an energy transfer unit having a pair of switches and an inductor. The pair of switches is coupled between the anode of the nth battery cell and the cathode of the 1st battery cell. The switch node of the pair of switches is connected to a first terminal of the inductor. A second terminal of the inductor is selectively coupled to the anode or the cathode of a target cell in the battery group. The energy transfer unit operates in a buck mode or a boost mode for transferring energy among the n battery cells of the battery group.

Another embodiment of the present invention discloses a method for balancing a battery group. The battery group has n battery cells connected by ordinal in a series structure, n is an integer higher than 2. Each battery cell has an anode and a cathode. The method comprises the following steps. A pair of switches coupled between the anode of the nth battery cell and the cathode of the 1st battery cell is engaged. A switch node of the pair of switches is connected to a first terminal of an inductor. The pair of switches and the inductor form an energy transfer unit. A target cell in the battery group is designated. A second terminal of the inductor is selectively coupled to the anode or the cathode of the target cell. The energy transfer unit is configured to operate in a buck mode or a boost mode for transferring energy among the n battery cells of the battery group.

Yet another embodiment of the present invention discloses an integrated control circuit for balancing a battery group. The battery group has n battery cells connected by ordinal in a series structure, n is an integer higher than 2. Each battery cell has an anode and a cathode. The integrated control circuit comprises 1st cell pin to (n+1)th cell pin, a first power pin, a second power pin and a pair of switches. The 1st cell pin is coupled to the cathode of the 1st battery cell. The 2nd cell pin to the (n+1)th cell pin are coupled by ordinal to the anode of the 1st battery cell to the anode of the nth battery cell. The first power pin is coupled to the second power pin through an inductor. The second power pin is selectively coupled to the anode or the cathode of a target cell in the battery group. The pair of switches is coupled between the (n+1) cell pin and the 1st cell pin. A switch node of the pair of switches is connected to the first power pin. The pair of switches and the inductor form an energy transfer unit. The energy transfer unit is configured to operate in a buck mode or a boost mode for transferring energy among the n battery cells of the battery group.

### BRIEF DESCRIPTION OF DRAWINGS

The present invention can be further understood with reference to the following detailed description and the appended drawings, wherein like elements are provided with like reference numerals.

FIG. 1 schematically shows a prior battery system 10 with a passive balance circuit.

FIG. 2 schematically shows a prior battery system 20 with an active balance circuit.

FIG. 3 schematically shows another prior battery system 30 with an active balance circuit.

FIG. 4 schematically shows still another prior battery system 40 with an active balance circuit.

FIG. 5 schematically shows a battery module 100 in accordance with an embodiment of the present disclosure.

FIG. 6 shows a battery module 100A in accordance with an embodiment of the present disclosure.

FIG. 7a shows an energy transfer unit 105A working in a buck mode in accordance with an embodiment of the present disclosure.

FIG. 7b shows an energy transfer unit 105A working in a boost mode in accordance with an embodiment of the present disclosure.

FIG. 8 schematically shows a battery module 100B in accordance with an embodiment of the present disclosure.

FIG. 9 schematically shows a system 200 for balancing a stacked battery group in accordance with an embodiment of the present disclosure.

FIG. 10 shows a system 200A for balancing a stacked battery group in accordance with an embodiment of the present disclosure.

FIG. 11 shows a flow diagram of a method 500 for balancing a battery group in accordance with an embodiment of the present invention.

FIG. 12 shows a flow diagram of a method 600 for balancing a stacked battery group in accordance with an embodiment of the present invention.

FIG. 13 shows an integrated circuit IC1 for balancing a battery group in accordance with an embodiment of the present disclosure.

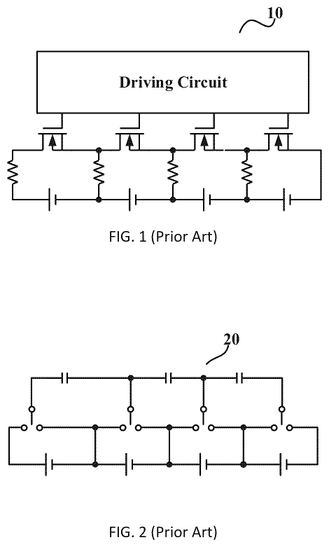

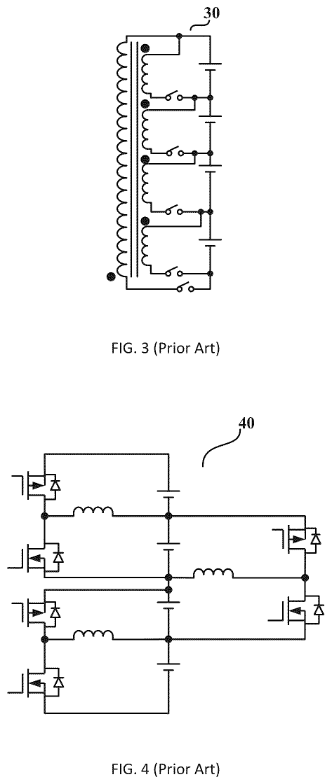

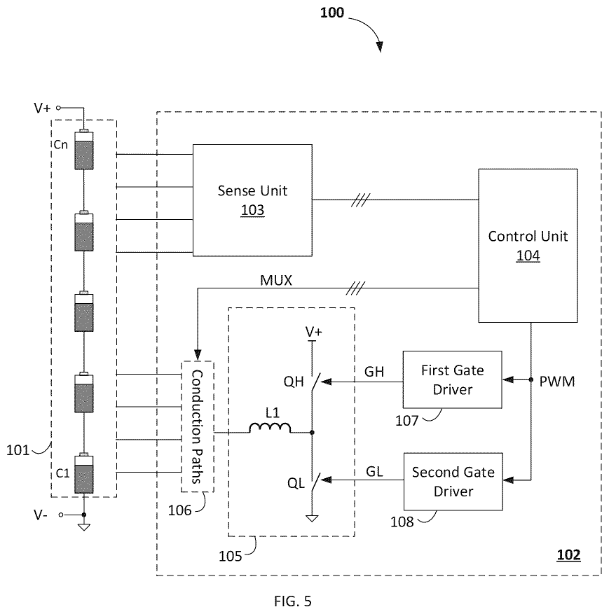

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

FIG. 5 schematically shows a battery module 100 in accordance with an embodiment of the present disclosure. As shown in FIG. 5, the battery module 100 comprises a battery group 101 and a BMS (battery management system) 102. The battery group 101 includes a plurality of battery cells connected by ordinal in a series structure. Each battery cell is the smallest unit and has an anode and a cathode. The plurality of battery cells are coupled between a positive battery group terminal V+and a negative battery group terminal V−. In one embodiment, the battery group 101 comprises 1st battery cell C1, 2nd battery cell C2, . . . , nth battery cell Cn, wherein n is an integer higher than 3 or equal to 3. In the embodiment shown in FIG. 5, the battery group 101 comprises battery cells C1˜C5 connected by ordinal in the series structure.

As shown in FIG. 5, the BMS 102 comprises a sense unit 103, a control unit 104, an energy transfer unit 105, a plurality of conduction paths 106, a first gate driver 107 and a second gate driver 108. The sense unit 103 is coupled to every single battery cell in the battery group 101 and is configured to sense battery cell voltage of each battery cell. The control unit 104 and the sense unit 103 are coupled together and are configured to receive and to monitor the battery cell voltage of every battery cell, to perform battery status estimation of each battery cell and to designate a target cell, and then to manage the battery cell's charge and discharge process for balancing the battery group 101.

In one embodiment, the target cell is the one who has the highest cell voltage in the battery group 101. In another embodiment, the target cell is the one who has the lowest cell voltage in the battery group 101. In yet another embodiment, the target cell is the one in which the battery cell voltage is less than an average voltage of the battery group 101. In another embodiment, the target cell is the one in which the battery cell voltage is higher than the average voltage of the battery group 101.

In one example, the control unit 104 is configured to get the average voltage of the battery group 101, and to calculate a difference between the target cell with the highest cell voltage and the average voltage. If the difference is higher than a predetermined threshold voltage, the control unit 104 starts the balance control to the target cell of the battery group 101. In detail, the control unit 104 outputs a multi-channel selection control signal MUX, to activate one of the plurality of conduction paths 106, and the control unit 104 provides a pulse width modulation signal PWM to the first gate driver 107 and the second driver 108 for driving a first pair of switches.

In one example, after the balance control to battery group 101 is finished, the control unit 104 is configured to get the average voltage of the battery group 101 again, and to calculate the difference between the target cell with the highest cell voltage and the average voltage. If the difference is less than the predetermined threshold voltage, the balance control is over. Accordingly, the control unit 104 stops providing the multi-channel selection control signal MUX and the pulse width modulation signal PWM.

In the embodiment shown in FIG. 5, the energy transfer unit 105 comprises the first pair of switches and an inductor L1. The first pair of switches comprises a high side switch QH and a low side switch QL connected in series between the anode of the nth battery cell Cn (i.e., the positive battery group terminal V+ as shown) and the cathode of the 1st batter cell C1 (i.e., a negative battery group terminal V− as shown). A switch node of the first pair of switches is connected to a first terminal of the inductor L1, and a second terminal of the inductor L1 is selectively coupled to the anode or the cathode of the target cell in the battery group 101.

In one embodiment, when the target cell's cell voltage exceeds the average voltage of the battery group 101 by a threshold voltage, the control unit 104 is configured to select one of the plurality of conduction paths 106, and the selected conduction path is closed to provide electronic connection between the target cell and the second terminal of the inductor L1. In one embodiment, the second terminal of the inductor L1 is firstly coupled to the anode of the target cell for a first time duration, and then the second terminal of the inductor L1 is coupled to the cathode of the target cell for a second time duration.

The first gate driver 107 and the second gate driver 108 are both controlled or activated by the pulse width modulation signal PWM. The first gate driver 107 and the second gate driver 108 are configured to receive the pulse width modulation signal PWM, and to provide non-overlapped a first driving signal GH and a second driving signal GL for driving the first pair of switches to work complementarily. Since the signals provided by the control unit 104 could be digital, and thus these signals have limited driving capability. And the first gate driver 107 and the second gate driver 108 are used to enhance the driving capability, to drive the high side switch QH and the low side switch QL.

In one embodiment, the second terminal of the inductor L1 is coupled to the anode of the target cell, the energy transfer unit 105 is configured to operate in a boost mode. In another embodiment, the second terminal of the inductor L1 is configured to the cathode of the target cell, the energy transfer unit 105 is configured to operate in a buck mode. In this balance control way, the target cell with the highest cell voltage is controlled to discharge energy to other battery cells in the battery group and the battery cells of the battery group 101 can be balanced.

In one embodiment, the target cell is the 1st battery cell C1 who has the highest cell voltage in the battery group 101, the second terminal of the inductor L1 is coupled to the anode of the 1st battery cell, and the energy transfer unit 105 is configured to work in the boost mode.

In one embodiment, the target cell is the nth battery cell Cn who has the highest cell voltage in the battery group 101, the second terminal of the inductor L1 is coupled to the cathode of the nth battery cell, and the energy transfer unit 105 is configured to work in the buck mode.

In another embodiment, the target cell is the one who has the highest cell voltage and one of from the 2nd battery cell to the (n−1)th battery cell (i.e., C2˜C(n−1)), the second terminal of the inductor L1 is selectively coupled to the anode of the target cell and the cathode of the target cell in a time-sharing way. In one example, the 3rd battery cell C3 is the battery cell with the highest cell voltage. The second terminal of the inductor L1 is firstly coupled to the cathode of the target cell (e.g., the 3rd battery cell C3), and the energy transfer unit 105 is firstly configured to work in the buck mode for a first time duration t1. Then the second terminal of the inductor L1 is coupled to the anode of the target cell (e.g., the 3rd battery cell C3), and the energy transfer unit 105 is configured to work in the boost mode for a second time duration t2.

In one embodiment, the target cell is the 1st battery cell C1 who has the lowest cell voltage in the battery group 101, the second terminal of the inductor L1 is coupled to the anode of the 1st battery cell C1, and the energy transfer unit 105 is configured to work in the buck mode.

In another embodiment, the target cell is the nth battery cell Cn who has the lowest cell voltage in the battery group 101, the second terminal of the inductor L1 is coupled to the cathode of the nth battery cell Cn, and the energy transfer unit 105 is configured to work in the boost mode.

In yet another embodiment, the target cell is the one who has the lowest cell voltage and is one of from the 2nd battery cell to the (n−1)th battery cell (i.e., C2˜C(n−1)), the second terminal of the inductor L1 is firstly coupled to the cathode of the target cell, the energy transfer unit 105 is firstly configured to work in the boost mode for a third time duration. Then the second terminal of the inductor L1 is coupled to the anode of the target cell, and the energy transfer unit 105 is configured to work in the buck mode for a fourth time duration.

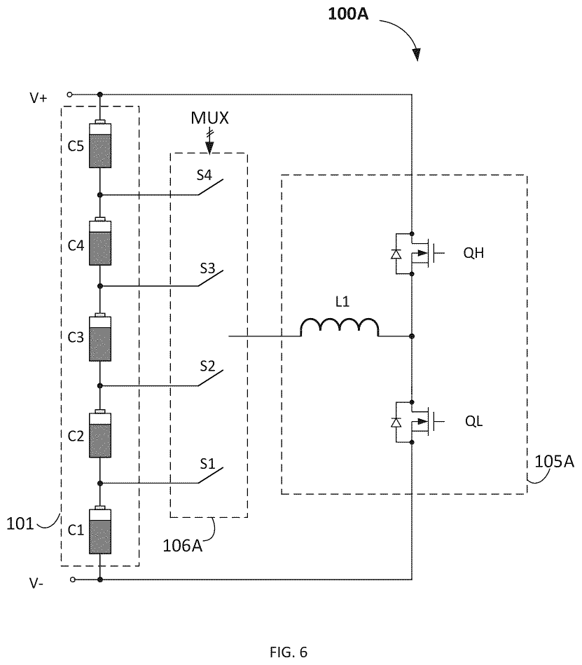

FIG. 6 shows a battery module 100A in accordance with an embodiment of the present disclosure. As shown in FIG. 6, for a 5-cell battery group 101, the plurality of conduction paths 106A comprise 4 switchable conductive paths S1˜S4 controlled or activated by the multi-channel selection control signal MUX. The energy transfer unit 105A comprises a first pair of switches and an inductor L1. The first pair of switches is composed of two MOSFETs.

In one embodiment, for a n-cell battery group 101, the plurality of conduction paths 106A comprise n−1 switchable conductive paths S1˜S (n−1). In the embodiment shown in FIG. 6, for the 5-cell battery group 101, the plurality of conduction paths comprises 4 switchable conductive paths S1˜S4 for selectively coupling the second terminal of the inductor L1 to the anode or the cathode of the target cell. In one embodiment, the multi-channel selection control signal MUX is configured to open or close the 4 switchable conductive paths S1˜S4, and only one switchable conductive path is closed at one time.

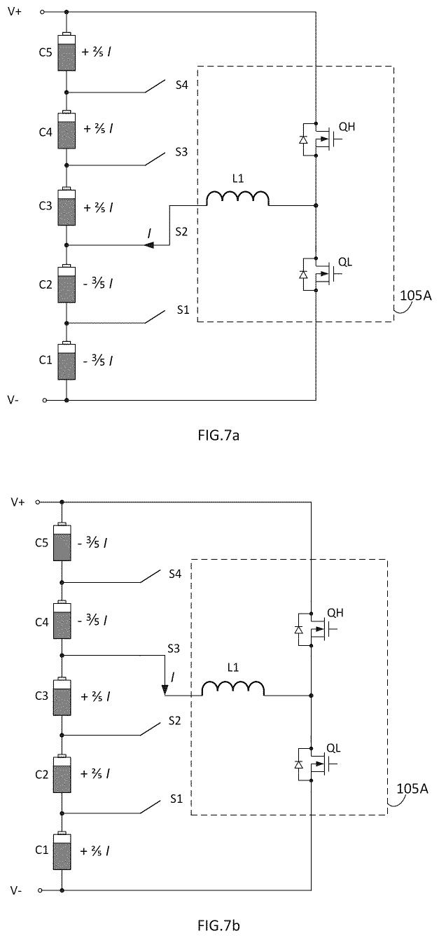

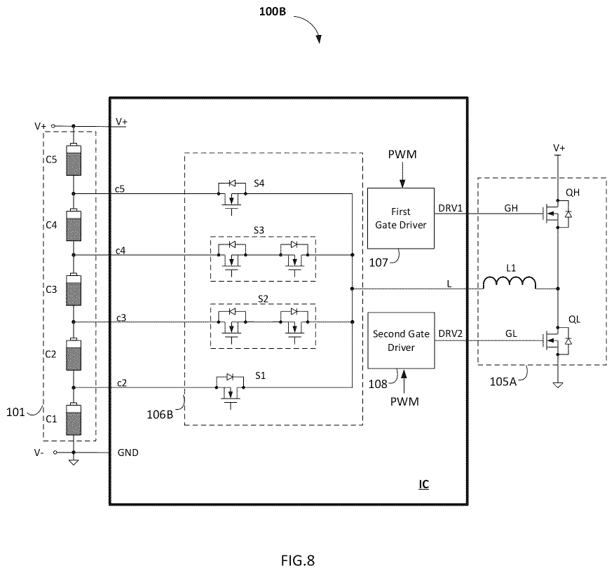

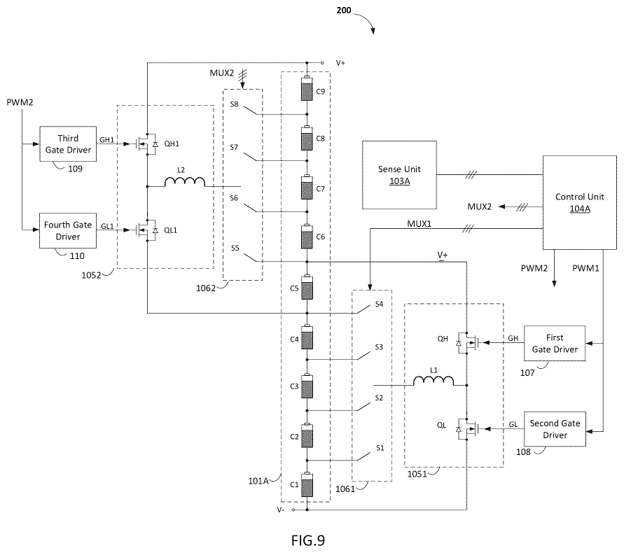

Several of the details of the embodiments are described below with reference to FIG. 7a and FIG. 7b, the 3rd battery cell C3 is an example of the target cell with the highest cell voltage in the battery group 101.

FIG. 7a shows an energy transfer unit 105A working in a buck mode in accordance with an embodiment of the present disclosure. In the embodiment shown in FIG. 7a, the 3rd battery cell C3′s cell voltage is the highest and exceeds the average voltage of the battery group 101 by a predetermined threshold voltage, the second terminal of the inductor L1 is firstly coupled to the cathode of the 3rd battery cell C3, the energy transfer unit 105A is configured to work in the buck mode. In detail, the high side switch QH is firstly turned on, the high side switch QH, the inductor L1 and the battery cells C3˜C5 form a discharge loop. The battery cells C3˜C5 are in the discharge state to discharge to the inductor L1. The inductor L1 stores the discharged energy from the battery cells C3˜C5. Subsequently, the high side switch QH is turned off, the low side switch QL is turned on. The inductor L1, battery cells C1 and C2 form a charge loop. The inductor L1 transfers energy to charge the battery cells C1 and C2, the energy is transferred from the inductor L1 to the battery cells C1 and C2. After that, the high side switch QH is turned on again, the low side switch QL is turned off, and the battery cells C3˜C5 starts to release energy. The process described above will be repeated. In this buck mode, the high side switch QH and the low side switch QL are turned on in turn and the switching of the first pair of switches is kept in the buck mode for the first time duration t1.

FIG. 7b shows an energy transfer unit 105A working in a boost mode in accordance with an embodiment of the present disclosure. After the first time duration t1, the second terminal of the inductor L1 is decoupled from the cathode of the target cell (e.g., the 3rd battery cell C3), and is recoupled to the anode of the target cell (e.g., the 3rd battery cell C3), the energy transfer unit 105A is configured to enter and to operate in the boost mode.

In detail, the low side switch QL is turned on, the low side switch QL, the inductor L1 and the battery cells C1˜C3 form a discharge loop. The battery cells C1˜C3 are in the discharge state, to discharge to the inductor L1. The inductor L1 stores the energy released by the battery cells C1˜C3. Subsequently, the low side switch QL is turned off, the high side switch QH is turned on, the high side switch QH, the inductor L1, the battery cells C4 and C5 form a charge loop. Thus, in the boost mode, the battery cells C4 and C5 are in the charge state. After that, the low side switch QL is turned on again and the process described above is repeated. In this boost mode, the high side switch QH and the low side switch QL are turned on in turn and the switching of the first pair of switches is kept in the boost mode for the second time duration t2.

Suppose all the battery cells in the batter group 101 have substantially the same impedance, and a current flowing through the inductor L1 is I, the current flowing out of the battery cells being discharged is about ⅖I, the current flowing into the battery cells being charged is about ⅗I. In detail, in the buck mode, the battery cells being charged are C1 and C2. While in the boost mode, the battery cells being charged are C4 and C5. It can be seen, the 3rd batter cell C3 is designated as the target cell with the highest cell voltage, which is always in the discharge state.

In one embodiment, the battery cells being charged (e.g., C1 and C2) in the battery group 101 in the buck mode have a first average voltage, the battery cells being charged (e.g., C4 and C5) in the battery group 101 in the boost mode have a second average voltage. The ratio of the first time duration t1 for the buck mode and the second time duration t2 for the boost mode is controlled to increase when the first average voltage is less than the second average voltage.

According to the embodiments, the energy transfer unit 105A can balance the battery group 101 with an active way, fast balancing with high current is performed among the battery cells in the battery group 101. Compared with the passive balance control, the active balance control described above can reduce the balance time and thus improve the efficiency of balance. In this balance control, the reliability and capacity of the battery module 100 are improved, the life span of the battery module 100 is also ensured, and accordingly, energy conservation and emission reduction are achieved.

FIG. 8 schematically shows a battery module 100B in accordance with an embodiment of the present disclosure. As shown in FIG. 8, the battery module 100B comprises a battery group 101, an energy transfer unit 105A and an integrated circuit IC. The integrated circuit IC and the energy transfer unit 105A work together to balance the battery cells in the battery group 101. In the embodiment shown in FIG. 8, the integrated circuit IC comprises a plurality of conduction paths 106B, a first gate driver 107, a second gate driver 108 and a plurality of pins. The plurality of pins comprises a ground pin GND, cell pins c2˜c5, a power supply pin V+, a first drive pin DRV1, a second drive pin DRV2, and a power pin L. The ground pin GND is coupled to the cathode of the 1st battery cell C1. Cell pins c2˜c5 are coupled to the cathodes of the battery cells C2˜C4, respectively. The power supply pin V+ is coupled to the anode of the 5th battery cell C5. The first drive pin DRV1 is coupled to a gate of the high side switch QH, and the second drive pin DRV2 is coupled to a gate of the low side switch QL. The power pin L is coupled to a second terminal of an inductor L1.

As shown in FIG. 8, the plurality of conduction paths 106B comprises 4 switchable conductive paths S1˜S4. One of the plurality of conduction paths 106B is selectively closed to provide electronic connection between the anode of the target cell the 1st battery cell to the (n−1)th battery cell (i.e., C1˜C4) and the second terminal of the inductor L1. In one embodiment, each of the 4 switchable conductive paths S1˜S4 comprises a pair of bi-directional MOSFETs connected in series.

In one embodiment, the switchable conductive path S1 between the anode of the 1st battery cell C1 and the second terminal of the inductor L1 comprises a MOSFET, the switchable conductive path S4 between the cathode of 5th battery cell C5 and the second terminal of the inductor L1 comprises a MOSFET.

FIG. 9 schematically shows a system 200 for balancing a stacked battery group in accordance with an embodiment of the present disclosure. As shown in FIG. 9, the system 200 comprises a stacked battery group 101A, a sense unit 103A, a control unit 104A, a first energy transfer unit 1051, a second energy transfer unit 1052, a first set of conduction paths 1061, a second set of conduction paths 1062, gate drivers 107˜110.

In one embodiment. the battery group 101A has 2n−1 (n is an integer higher than 2) battery cells connected by ordinal in a series structure. Each battery cell has an anode and a cathode. The 2n−1 battery cells are coupled between a positive battery group terminal V+ and a negative battery group terminal V−. The 2n−1 battery cells are grouped into two sub-groups in which the nth battery cell is shared by a first sub-group and a second sub-group. In the embodiment shown in FIG. 9, the battery group 101A has 9 battery cells (C1˜C9) connected by ordinal. The battery cells C1˜C5 form the first sub-group, the battery cells C5˜C9 form the second sub-group, and the 5th battery cell C5 is shared by the first sub-group and the second sub-group.

In the embodiment shown in FIG. 9, the first set of conduction paths 1061 comprise 4 switchable conductive paths S1˜S4 controlled or activated by a multi-channel selection control signal MUX1. The second set of conduction paths 1062 comprise 4 switchable conductive paths S5˜S8 controlled or activated by a multi-channel selection control signal MUX2.

As shown in FIG. 9, the sense unit 103A is coupled to every single battery cell in the battery group 101A and is configured to sense battery cell voltage of each battery cell. The control unit 104A and the sense unit 103A are coupled together and are configured to receive and monitor the battery cell voltage of every single battery cell, to perform battery status estimation of each battery cell and to designate a first target cell for the first sub-group and to designate a second target cell for the second sub-group, and then to manage the battery cell's charge and discharge process for balancing the battery group 101.

In one embodiment, the first target cell or the second target cell is the one who has the highest cell voltage in the corresponding sub-group. In a further embodiment, when a balance demand of the first sub-group comes, the control unit 104A provides the multi-channel selection control signal MUX1 to close one of the first set of conduction paths 1061, at the same time, provides a pulse width modulation signal PWM1 to the first gate driver 107 and the second gate driver 108, to control the first pair of switches (QH and QL) to work complementarily. When a balance demand of the second sub-group comes, the control unit 104A also provides the multi-channel selection control signal MUX2 to close one of the second set of conduction paths 1062, at the same time, provides a pulse width modulation signal PWM2 to the third gate driver 109 and the fourth gate driver 110, to control the second pair of switches (QH1 and QL1) to work complementarily.

In the embodiment shown in FIG. 9, the first energy transfer unit 1051 comprises a first pair of switches (QH and QL) and a first inductor L1. The first pair of switches is coupled between the anode of the nth battery cell Cn and the cathode of the 1st battery cell C1, a switch node of the first pair of switches is connected to a first terminal of the first inductor L1, and a second terminal of the first inductor L1 is selectively coupled to the anode or the cathode of a first target cell in the first sub-group.

In response to the pulse width modulation signal PWM1, the first gate driver 107 and the second gate driver 108 provides a first gate driving signal GH and a second gate driving signal GL to drive the first pair of switches for balancing the battery cells in the first sub-group.

In one embodiment, the first target cell in the first sub-group is designated and the second terminal of the first inductor L1 is selectively coupled to the cathode of the first target cell or the anode of the first target cell. The first gate driver 107 and the second gate driver 108 are controlled or activated by the pulse width modulation signal PWM1, are configured to provide the first gate driving signal GH and the second driving signal GL to drive the first pair of switches. In one embodiment, when the second terminal of the first inductor L1 is coupled to the anode of the first target cell, the first energy transfer unit 1051 is configured in the boost mode. In another embodiment, when the second terminal of the first inductor L1 is coupled to the cathode of the first target cell, the first energy transfer unit 1051 is configured to operate in the buck mode.

In an example, the first target cell is the 3rd battery cell C3 who has the highest cell voltage in the first sub-group. The second terminal of the first inductor L1 is firstly coupled to the cathode of the 3rd battery cell C3, and the first energy transfer unit 1051 is configured to operate in the buck mode for a first time duration t1. Subsequently, the second terminal of the first inductor L1 is coupled to the anode of the 3rd battery cell C3, the first energy transfer unit 1051 is configured to operate in the boost mode for a second time duration t2. The battery cells being charged (C1 and C2) in the first sub-group in the buck mode have a first average voltage, the battery cells being charged (C4 and C5) in the first sub-group in the boost mode have a second average voltage, and the ratio of the first time duration t1 and the second time duration t2 is increased when the first average voltage is less than the second average voltage.

In the embodiment shown in FIG. 9, the second energy transfer unit 1052 comprises a second pair of switches (QH1 and QL1) and a second inductor L2. The second pair of switches is coupled between the anode of the (2n−1)th battery cell C(2n−1) and the cathode of the nth battery cell Cn, a switch node of the second pair of switches is connected to a first terminal of the second inductor L2, and a second terminal of the second inductor L2 is selectively coupled to the anode or the cathode of a second target cell in the second sub-group.

In response to the pulse width modulation signal PWM2, the second gate driver 109 and the second gate driver 110 are configured to provide a third gate driving signal GH1 and a fourth gate driving signal GL1 to drive the second pair of switches for balancing the battery cells in the second sub-group.

In one embodiment, the second target cell is the one who has the highest cell voltage in the second sub-group, and the second terminal of the second inductor L2 is selectively coupled to the cathode of the second target cell or the anode of the second target cell in a time-sharing way. In one embodiment, when the second terminal of the second inductor L2 is coupled to the anode of the second target cell, and the second energy transfer unit 1052 is configured to work in the boost mode. In another embodiment, when the second terminal of the second inductor L2 is coupled to the cathode of the second target cell, the second energy transfer unit 1052 is configured to operate in the buck mode.

In an example, the 7th battery cell C7 has the highest cell voltage in the second sub-group. The second terminal of the second inductor L2 is coupled to the cathode of the 7th battery cell C7 and the second energy transfer unit 1052 is configured to work in the buck mode for a third time duration t3. Subsequently, the second terminal of the second inductor L2 is coupled to the anode of the 7th battery cell C7, the second energy transfer unit 1052 is configured to operate in the boost mode for a fourth time duration t4. The battery cells being charged (C5 and C6) in the second sub-group in the buck mode have a third average voltage, the battery cells being charged (C8 and C9) in the second sub-group in the boost mode have a fourth average voltage, and the ratio of the third time duration t3 and the fourth time duration t4 is increased when the third average voltage is less than the fourth average voltage.

In other embodiments, the control unit 104A is further configured to monitor a difference between an average voltage of the first sub-group and an average voltage of the second sub-group, and the balance demand between the first sub-group and the second sub-group is determined when the difference is higher than a second predetermined threshold voltage.

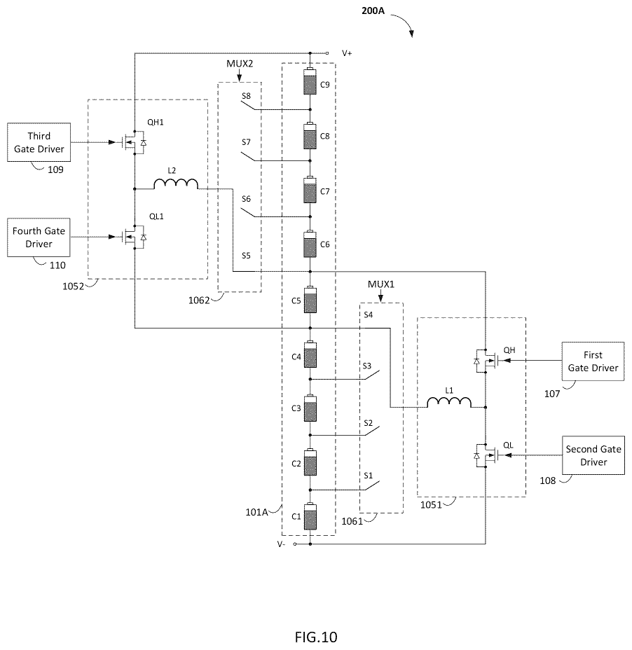

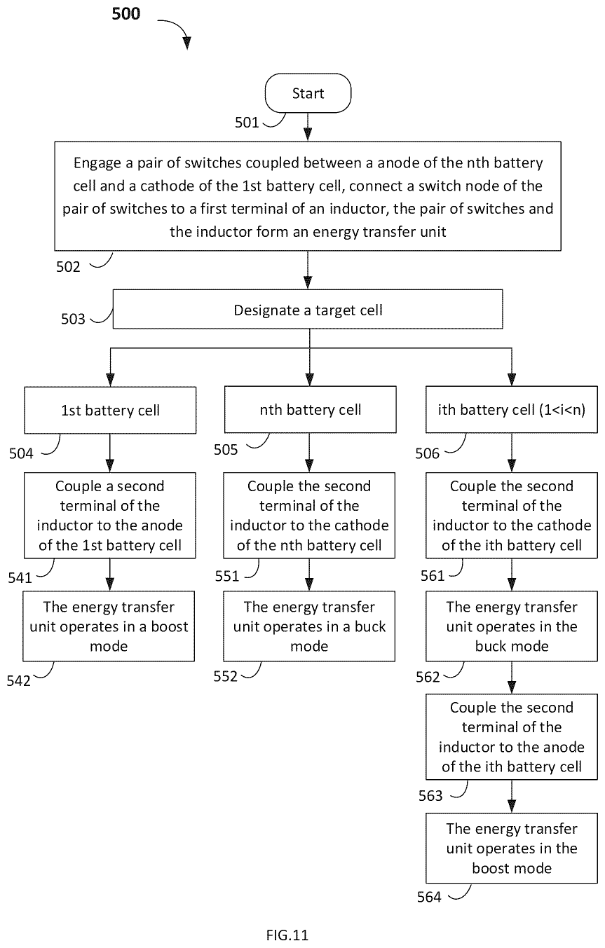

FIG. 10 shows a system 200A for balancing a stacked battery group in accordance with an embodiment of the present disclosure. As shown in FIG. 10, in response to balance demand between the first sub-group and the second sub-group, the multi-channel selection control signal MUX1 provided by the control unit 104A is configured to close the switchable conductive path s4, to couple the second terminal of the first inductor L1 to the cathode of the nth battery cell (e.g., the 5th battery cell). At the same time, the multi-channel selection control signal MUX2 provided by the control unit 104A is configured to close the switchable conductive path S5, to couple the second terminal of the second inductor L2 to the anode of the nth battery cell (e.g., the 5th battery cell).

In one embodiment, in response to the difference between the average voltage of the first sub-group and the average voltage of the second sub-group being higher than a predetermined threshold voltage, the first energy transfer unit 1051 and the second energy transfer unit 1052 are both configured to work in the boost mode.

In detail, the first energy transfer unit 1051 is controlled by the first gate driver 107 and the second gate driver 108 which are activated by the pulse width modulation signal PWM1. The second energy transfer unit 1052 is controlled by the third gate driver 109 and the fourth gate driver 110 which are activated by the pulse width modulation signal PWM2. In response to the difference between the average voltage of the second sub-group and the average voltage of the first sub-group being higher than the predetermined threshold voltage, the first energy transfer unit 1051 and the second energy transfer unit 1052 are both configured to work in the buck mode.

FIG. 11 shows a flow diagram of a method 500 for balancing a battery group in accordance with an embodiment of the present invention. The battery group has n battery cells connected by ordinal in a series structure, wherein n is an integer higher than 2. Each battery cell has an anode and a cathode. The method 500 comprises steps 501˜506.

At step 501, the process starts.

At step 502, a pair of switches coupled between the anode of the nth battery cell and the cathode of the 1st battery cell is engaged. A switch node of the pair of switches is connected to a first terminal of an inductor. The pair of switches and the inductor form an energy transfer unit.

At step 503, a target cell of the battery group is designated.

In one embodiment, the target cell is the one in which the battery cell voltage is higher than an average voltage of the battery group. In another embodiment, the target cell is the one in which the battery cell voltage is less than an average voltage of the battery group.

In one embodiment, the target cell is the one who has the lowest cell voltage in the battery group. In another embodiment, the target cell is the one who has the highest cell voltage in the battery group.

At step 504, if the target cell is the 1st battery cell who has the highest cell voltage in the battery group, the process goes into steps 541 and 542. A second terminal of the inductor is coupled to the anode of the 1st battery cell (step 541), and the energy transfer unit is configured to work in a boost mode (step 542).

At step 505, if the target cell is the nth battery cell who has the highest cell voltage in the battery group, the process goes into steps 551 and 552. The second terminal of the inductor is coupled to the cathode of the nth battery cell (step 551), and the energy transfer unit is configured to work in a buck mode (step 552).

At step 506, if the target cell is the one who has the highest cell voltage from the 2nd battery cell to the (n−1)th battery cell, the process goes into steps 561˜564. The second terminal of the inductor is firstly coupled to the cathode of the target cell (step 561), the energy transfer unit is firstly configured to work in the buck mode for a first time duration (step 562). And then the second terminal of the inductor is coupled to the anode of the target cell (step 563), and the energy transfer unit is configured to work in the boost mode for a second time duration (step 564).

In one embodiment, the battery cells being charged in the battery group in the buck mode have a first average voltage, the battery cells being charged in the battery group in the boost mode have a second average voltage, and the ratio of the first time duration and the second time duration is increased when the first average voltage is less than the second average voltage.

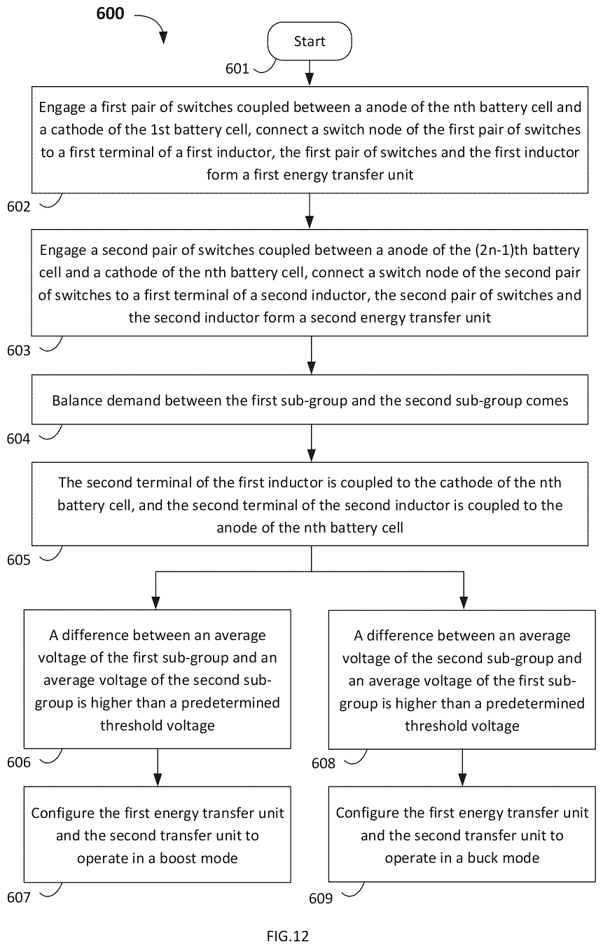

FIG. 12 shows a flow diagram of a method 600 for balancing a stacked battery group in accordance with an embodiment of the present invention. The stacked battery group has 2n−1 battery cells connected by ordinal in a series structure, wherein n is an integer higher than 2. Each battery cell has an anode and a cathode. The 2n−1 battery cells are grouped into two sub-groups in which the nth battery cell is shared by a first sub-group and a second sub-group. The method 600 comprises steps 601˜609.

At step 601, the process starts.

At step 602, a first pair of switches coupled between the anode of the nth battery cell and the cathode of the 1st battery cell is engaged, a switch node of the first pair of switches is connected to a first terminal of a first inductor. The first pair of switches and the first inductor form a first energy transfer unit.

At step 603, a second pair of switches coupled between the anode of the (2n−1)th battery cell and the cathode of the nth battery cell is engaged, a switch node of the second pair of switches is connected to a first terminal of a second inductor. The second pair of switches and the second inductor form a second energy transfer unit.

At step 604, balance demand between the first sub-group and the second sub-group comes.

At step 605, the second terminal of the first inductor is coupled to the cathode of the nth battery cell, and the second terminal of the second inductor is coupled to the anode of the nth battery cell.

At step 606, a difference between an average voltage of the first sub-group and an average voltage of the second sub-group is higher than a predetermined threshold voltage.

At step 607, the first energy transfer unit and the second transfer unit are configured to operate in the boost mode.

At step 608, a difference between an average voltage of the second sub-group and an average voltage of the first sub-group is higher than a predetermined threshold voltage.

At step 609, the first energy transfer unit and the second transfer unit are configured to operate in the buck mode.

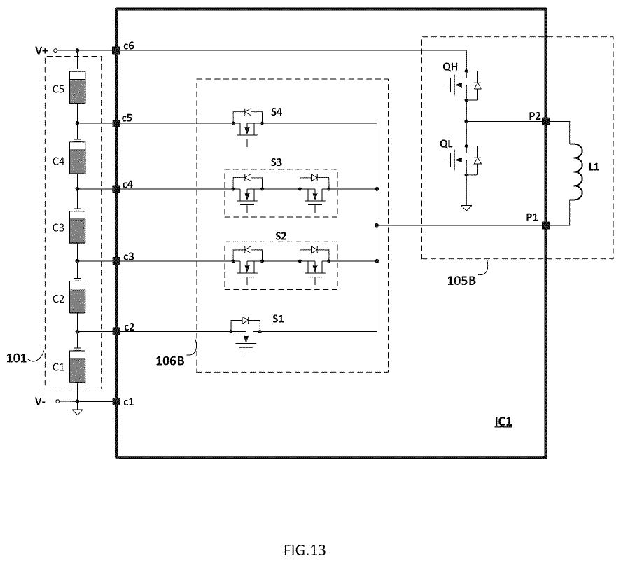

FIG. 13 shows an integrated circuit IC1 for balancing a battery group in accordance with an embodiment of the present disclosure. As shown in FIG. 13, the integrated control circuit IC1 is configured to balance battery cells in the battery group 101. The battery group 101 has n battery cells connected by ordinal in a series structure, wherein n is an integer higher than 2. Each battery cell has an anode and a cathode. The integrated control circuit IC1 comprises 1st cell pin to (n+1)th cell pin (i.e., c1˜c(n+1)), a first power pin P2, a second power pin P1, a pair of switches (i.e., QH and QL as shown).

As shown in FIG. 13, the 1st cell pin c1 is coupled to the cathode of the 1st battery cell C1. The 2nd cell pin to the (n+1)th cell pin (i.e., c2˜c(n+1)) are coupled by ordinal to the anode of the 1st battery cell to the anode of the nth battery cell (i.e., the anodes of C1˜Cn). The first power pin P2 is coupled to the second power pin P1 through an inductor L1. The second power pin P1 is selectively coupled to the anode or the cathode of a target cell in the battery group 101. The pair of switches is coupled between the (n+1) cell pin c(n+1) and the 1st cell pin c1. A switch node of the pair of switches is connected to the first power pin P2. The pair of switches and the inductor L1 form an energy transfer unit 105B. The energy transfer unit 105B is configured to operate in a buck mode or a boost mode for transferring energy among the n battery cells of the battery group 101.

In the embodiment shown in FIG. 13, the integrated control circuit IC1 further comprises n−1 conduction paths. One of the n−1 conduction paths is selectively closed to provide electronic connection between one of from the 2nd cell pin c2 to the nth cell pin cn and the second power pin P1. The integrated control circuit IC1 shown in FIG. 13 is a relatively simple structure and low cost, only the inductor L1, the pair of switches and n−1 conduction paths are required for balancing the n-cell battery group 101.

In one embodiment, a system for balancing a battery group is provided. The battery group has a plurality of battery cells connected by ordinal in a series structure. Each battery cell has an anode and a cathode, the plurality of battery cells are grouped into multiple sub-groups in which the nth cell is shared by a first sub-group and a second sub-group. In one embodiment, the first sub-group and the second sub-group have different number of battery cells. In another embodiment, the first sub-group and the second sub-group have same number of battery cells.

The system at least comprises a first integrated control circuit and a second integrated control circuit. The first integrated control circuit is configured to balance battery cells in the first sub-group. The second integrated control circuit is configured to balance battery cells in the second sub-group. Each integrated control circuit comprises 1st cell pin to (n+1)th cell pin, a first power pin, a second power pin, a pair of switches. The 1st cell pin is coupled to the cathode of the 1st battery cell of the corresponding sub-group. The 2nd cell pin to (n+1)th cell pin are coupled by ordinal to the anode of the 1st battery cell to the anode of the nth battery cell of the corresponding sub-group. The first power pin is coupled to the second power pin through a respective inductor. The second power pin is selectively coupled to the anode or the cathode of a target cell in the corresponding sub-group. The pair of switches is coupled between the anode of nth battery cell and the cathode of 1st battery cell in the corresponding sub-group. A switch node of the pair of switches is connected to the first power pin. The pair of switches and the respective inductor form an energy transfer unit. The energy transfer unit is configured to operate in a buck mode or a boost mode for transferring energy among the battery cells of the corresponding sub-group.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A battery module for balancing a battery group with n (n≥3) battery cells connected by ordinal in a series structure, the battery module comprising:
an energy transfer unit having a pair of switches and an inductor, wherein the pair of switches is configured to be coupled between an anode of the nth battery cell and a cathode of the 1st battery cell, a switch node of the pair of switches is connected to a first terminal of the inductor, and a second terminal of the inductor is configured to be selectively coupled to an anode or a cathode of a target cell in the battery group; and
wherein the energy transfer unit is configured to operate in a buck mode or a boost mode for transferring energy among the n battery cells of the battery group.

2. The battery module of claim 1, wherein:
if the target cell is the 1st battery cell who has the highest cell voltage in the battery group, the second terminal of the inductor is coupled to the anode of the 1st battery cell, and the energy transfer unit is configured to work in the boost mode; and
if the target cell is the nth battery cell who has the highest cell voltage in the battery group, the second terminal of the inductor is coupled to the cathode of the nth battery cell, and the energy transfer unit is configured to work in the buck mode.

3. The battery module of claim 1, wherein:
if the target cell is the one who has the highest cell voltage from the 2nd battery cell to the (n−1)th battery cell, the second terminal of the inductor is firstly coupled to the cathode of the target cell, and the energy transfer unit is firstly configured to work in the buck mode for a first time duration; and
then the second terminal of the inductor is coupled to the anode of the target cell, and the energy transfer unit is configured to work in the boost mode for a second time duration.

4. The battery module of claim 3, wherein:
the battery cells being charged in the battery group in the buck mode have a first average voltage, the battery cells being charged in the battery group in the boost mode have a second average voltage, and the ratio of the first time duration and the second time duration is increased when the first average voltage is less than the second average voltage.

5. The battery module of claim 1, wherein:
if the target cell is the 1st battery cell who has the lowest cell voltage in the battery group, the second terminal of the inductor is coupled to the anode of the 1st battery cell, and the energy transfer unit is configured to work in the buck mode; and
if the target cell is the nth battery cell who has the lowest cell voltage in the battery group, the second terminal of the inductor is coupled to the cathode of the nth battery cell, and the energy transfer unit is configured to work in the boost mode.

6. The battery module of claim 1, wherein:
if the target cell is the one who has the lowest cell voltage from the 2nd battery cell to the (n−1)th battery cell, the second terminal of the inductor is firstly coupled to the cathode of the target cell, the energy transfer unit is firstly configured to work in the boost mode for a first time duration;
and then the second terminal of the inductor is coupled to the anode of the target cell, and the energy transfer unit is configured to work in the buck mode for a second time duration.

7. The battery module of claim 6, wherein:
the battery cells being discharged in the battery group in the boost mode have a third average voltage, the battery cells being discharged in the battery group in the buck mode have a fourth average voltage, and the ratio of the first time duration and the second time duration is increased when the third average voltage is less than the fourth average voltage.

8. The battery module of claim 1, further comprising:
n−1 conduction paths, wherein one of the n−1 conduction paths is selectively closed to provide electronic connection between the anode of the target cell from the 1st battery cell to the (n−1)th battery cell and the second terminal of the inductor.

9. The battery module of claim 8, wherein:
the conduction path between the anode of the 1st battery cell and the second terminal of the inductor comprises a first switch;
the conduction path between the cathode of nth battery cell and the second terminal of the inductor comprises a (n−1)th switch; and
each of the rest of the n−1 conduction paths comprises a pair of bi-directional switches connected in series.

10. The battery module of claim 1, further comprising:
a first gate driver and a second gate driver respectively configured to provide a first driving signal and a second driving signal for driving the pair of switches to work complementarily based on a pulse width modulation signal.

11. A method for balancing a battery group, wherein the battery group has n battery cells connected by ordinal in a series structure, wherein n is an integer higher than 2, each battery cell has an anode and a cathode, the method comprising:
engaging a pair of switches coupled between the anode of the nth battery cell and the cathode of the 1st battery cell;
connecting a switch node of the pair of switches to a first terminal of an inductor, wherein the pair of switches and the inductor form an energy transfer unit;
designating a target cell in the battery group;
selectively coupling a second terminal of the inductor to the anode or the cathode of the target cell; and
configuring the energy transfer unit to operate in a buck mode or a boost mode for transferring energy among the n battery cells of the battery group.

12. The method of claim 11, wherein if the target cell is the one in which the battery cell voltage is higher than an average voltage of the battery group, and wherein:
if the target cell is the 1st battery cell, the second terminal of the inductor is coupled to the anode of the 1st battery cell, and the energy transfer unit is configured to work in the boost mode; and
if the target cell is the nth battery cell, the second terminal of the inductor is coupled to the cathode of the nth battery cell, and the energy transfer unit is configured to work in the buck mode.

13. The method of claim 11, wherein if the target cell is the one in which the battery cell voltage is higher than an average voltage of the battery group, and wherein:
if the target cell is one of from the 2nd battery cell to the (n−1)th battery cell, the second terminal of the inductor is firstly coupled to the cathode of the target cell, the energy transfer unit is firstly configured to work in the buck mode for a first time duration; and
then the second terminal of the inductor is coupled to the anode of the target cell, the energy transfer unit is configured to work in the boost mode for a second time duration.

14. The method of claim 13, wherein:
the battery cells being charged in the battery group in the buck mode have a first average voltage, the battery cells being charged in the battery group in the boost mode have a second average voltage, and the ratio of the first time duration and the second time duration is increased when the first average voltage is less than the second average voltage.

15. The method of claim 11, wherein if the target cell is the one in which the battery cell voltage is less than an average voltage of the battery group, and wherein:
if the target cell is the 1st battery cell, the second terminal of the inductor is coupled to the anode of the 1st battery cell, and the energy transfer unit is configured to work in the buck mode; and
if the target cell is the nth battery cell, the second terminal of the inductor is coupled to the cathode of the nth battery cell, and the energy transfer unit is configured to work in the boost mode.

16. The method of claim 11, wherein if the target cell is the one in which the battery cell voltage is less than an average voltage of the battery group;
the target cell is one of from the 2nd battery cell to the (n−1)th battery cell, the second terminal of the inductor is firstly coupled to the cathode of the target cell, the energy transfer unit is configured to work in the boost mode for a first time duration; and
then the second terminal of the inductor is coupled to the anode of the target cell, the energy transfer unit is configured to work in the buck mode for a second time duration.

17. The method of claim 16, wherein:
the battery cells being discharged in the battery group in the boost mode have a third average voltage, and the battery cells being discharged in the battery group in the buck mode have a fourth average voltage, and the ratio of the first time duration and the second time duration is increased when the third average voltage is less than the fourth average voltage.

18. An integrated control circuit for balancing a battery group with n battery cells connected by ordinal in a series structure, the integrated control circuit comprising:
1st cell pin, configured to be coupled to a cathode of the 1st battery cell;
2nd cell pin to (n+1)th cell pin, coupled by ordinal to the anode of the 1st battery cell to the anode of the nth battery cell;
a first power pin, configured to be coupled to a second power pin through an inductor;
the second power pin, configured to be selectively coupled to the anode or the cathode of a target cell in the battery group;
a pair of switches coupled between the (n+1) cell pin and the 1st cell pin, a switch node of the pair of switches is connected to the first power pin; and
wherein pair of switches is configured to work with the inductor to form an energy transfer unit, and to operate in a buck mode or a boost mode for transferring energy among the battery cells of the battery group.

19. The integrated control circuit of claim 18, further comprising:
n−1 conduction paths, wherein one of the n−1 conduction paths is selectively closed to provide electronic connection between one of from the 2nd cell pin to the nth cell pin and the second power pin.

20. The integrated control circuit of claim 19, wherein:
the conduction path between the 2nd cell pin and the second power pin comprises a first switch;
the conduction path between the nth cell pin and the second power pin comprises a (n−1)th switch; and
each of the rest of the n−1 conduction paths comprises a pair of bi-directional switches connected in series.
